(19) United States
(12) Patent Application Publication
(10) Pub. No.: US 2015/0175798 A1
(43) Pub. Date: Jun. 25, 2015

(54) POLYOXYMETHYLENE POLYMER WITH PLASTICIZER AND IMPACT MODIFIER

(71) Applicant: Ticona LLC, Florence, KY (US)

(72) Inventor: Jeremy H. Klug, Union, KY (US)

(21) Appl. No.: 14/574,985

(22) Filed: Dec. 18, 2014

Related U.S. Application Data
(60) Provisional application No. 61/918,782, filed on Dec. 20, 2013.

(51) Int. Cl. C08L 59/04

(52) U.S. Cl. CPC C08L 59/04

(57) ABSTRACT

Polymer compositions contain a polyoxymethylene polymer combined with a plasticizer and impact modifier. In accordance with the present disclosure, the plasticizer can have a relatively high boiling point, such as greater than 300° C. In one embodiment, the plasticizer may comprise a dibenzoate or hexanoate. Plasticizers made in accordance with the present disclosure are resistant to evaporative loss while increasing physical properties. The polymer composition can be molded into various different articles, such as tubes, fasteners, clips, cable ties and sporting goods.

### RELATED APPLICATIONS

The present application is based on and claims priority to U.S. Provisional Patent application Ser. No. 61/918,782, filed on Dec. 20, 2013, which is incorporated herein by reference.

### BACKGROUND

Polyacetal polymers, which are commonly referred to as polyoxymethylene polymers, have become established as exceptionally useful engineering materials in a variety of applications. Polyoxymethylene polymers, for instance, are widely used in constructing molded parts, such as parts for use in the automotive industry and the electrical industry. Polyoxymethylene polymers have excellent mechanical properties, fatigue resistance, abrasion resistance, and chemical resistance.

Although polyoxymethylene polymers have excellent physical characteristics, the polymers tend to be stiff making them unsuitable in applications where flexible properties and/or impact resistance properties are needed. In the past, in order to increase the flexibility of polyoxymethylene polymers, the polymers have been combined with impact modifiers and/or plasticizers. In one embodiment, for instance, polyoxymethylene polymers have been combined with impact modifiers comprising thermoplastic elastomers. Excellent impact resistant properties have been obtained when combining the polyoxymethylene polymer with a thermoplastic elastomer and an appropriate coupling agent. Although the above composition has made great advances in the art, the composition is somewhat expensive and complicated to produce.

In other embodiments, polyoxymethylene polymers have been combined with plasticizers. During molding, however, the plasticizers have a tendency to degrade and/or evaporate. Consequently, problems have been experienced in optimizing the use of a plasticizer with a polyoxymethylene polymer.

In view of the above, a need exists for an improved flexible polyoxymethylene polymer composition and to articles formed from such a composition.

### SUMMARY OF THE INVENTION

Generally speaking, the present disclosure is directed to a flexible polymer composition. The polymer composition can be formed into an article through any suitable molding process such as injection molding, extrusion, blow molding, or deep drawing and extrusion blow molding. The molded article can be formed, for instance, into any suitable shape, such as a cable, a pipe, a tube, a fuel pipe, a fuel hose, a brake hose, a connection assembly, or any other molded article or combination thereof. It is also to be understood that the articles can be corrugated, flat, or a combination thereof. The articles may also be multilayered such that they contain one or more layers.

More specifically, the polymer composition comprises a plasticized, impact modified polyoxymethylene composition. In one embodiment, the polymer composition contains a polyoxymethylene polymer combined with a plasticizer and an impact modifier. In accordance with the present disclosure, the plasticizer is selected so as to minimize evaporative loss during processing. A plasticizer can also be selected that dramatically improves some of the properties of the composition in comparison to the same composition containing no plasticizer or the same composition containing a conventional sulfonamide plasticizer. For instance, the polymer composition of the present disclosure can have excellent elastic properties. The composition may display a strain at break of greater than 60%, such as greater than 65%. The strain at break is generally less than 100%.

In one embodiment, a plasticizer may be selected for use in the present disclosure that has a relatively high boiling point, such as a boiling point of greater than about 300° C. when measured at 760 mm/Hg. For instance, the boiling point can be greater than about 320° C., such as greater than about 330° C., such as even greater than about 340° C.

In one embodiment, the plasticizer may comprise a dialkylene glycol dibenzoate. In an alternative embodiment, the plasticizer may comprise an alkylene glycol hexanoate. In one particular embodiment, the plasticizer comprises triethylene glycol bis(2-ethylhexanoate). Polymer compositions in accordance with the present disclosure can display minimal evaporative loss. For example, after being placed in a hot air oven at 90° C. for 600 hours, polymer compositions made according to the present disclosure may have a mass loss of less than about 1.1%, such as less than about 1.0%, such as less than 0.9%, such as less than about 0.8%, such as less than about 0.7%, such as less than about 0.6%. The mass loss is generally greater than about 0.05%.

Of particular advantage, plasticizers of the present disclosure can be incorporated into the composition and may improve the properties of the composition without having to use a coupling agent, and particularly an isocyanate coupling agent that couples the impact modifier to the polyoxymethylene polymer. The plasticizer can also be used to minimize the amount of plasticizer and impact modifier present in the composition allowing for greater amounts of the polyoxymethylene polymer to be used.

The impact modifier can comprise a thermoplastic elastomer. In one embodiment, the thermoplastic elastomer can be a thermoplastic polyurethane elastomer. The impact modifier can be present in the polymer composition in an amount ranging up to about 50% by weight based on the total weight of the polymer composition. As described above, however, the plasticizer of the present disclosure may allow for the amount of impact modifier to be reduced. In one embodiment, for instance, the impact modifier is present in the composition in an amount less than about 5% by weight, such as in an amount less than about 2.5% by weight.

The thermoplastic elastomer and the plasticizer may be present in the composition at a weight ratio of from about 2:1 to about 1:5, such as from about 1:1 to about 1:5, such as from about 1:1.5 to about 1:3.5. In one embodiment, the plasticizer is present in the composition in an amount less than 20% by weight, such as in an amount less than 10% by weight, such as in an amount less than 8% by weight, such as in an amount from about 1% to about 8% by weight.

Other features and aspects of the present disclosure are discussed in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 shows a corrugated tube made of the polymer composition of the present disclosure;

FIG. 2 shows a fuel system utilizing a corrugated tube made of the polymer composition of the present disclosure.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polymer composition that is well suited to being molded into articles having increased yield strain and flexibility. The present disclosure is also directed to a process for producing molded parts containing the polymer composition.

More particularly, the polymer composition of the present disclosure comprises a plasticized, impact modified polyoxymethylene composition. In accordance with the present disclosure, one or more plasticizers are selected for use in the composition that provide various advantages and benefits. For example, in one embodiment, a plasticizer is selected that is resistant to evaporative loss during heat aging or processing of the composition. For example, it was recognized that plasticizers used in the past, such as sulfonamides, have a tendency to migrate within the polymer composition and ultimately leave the composition over time, especially when the composition is subjected to high temperatures or to thermal cycles. Consequently, over time, the polymer composition and molded parts made therefrom have a tendency to become more stiff and therefore susceptible to cracking after being stressed or subjected to an impact. In accordance with the present disclosure, however, plasticizers are selected that are resistant to evaporative loss. In one embodiment, for instance, a plasticizer is selected that has a relatively high boiling point. For instance, a plasticizer can be selected that has a boiling point at 760 mm/Hg of greater than about 300° C., such as greater than about 320° C., such as greater than about 330° C., such as greater than about 340° C. The boiling point in the plasticizer is generally less than about 450° C.

In addition to or as an alternative to improving evaporative loss, plasticizers may also be selected in accordance with the present disclosure that improve processing and/or physical properties. For instance, it was discovered that plasticizers in accordance with the present disclosure can improve weld line performance when the composition is molded into an article and welded to an opposing surface. In particular, it was discovered that the plasticizers of the present disclosure improve the ductility of the composition after a weld bond is formed. In addition, the plasticizers can dramatically improve break strain. In one embodiment, for instance, a composition can be formulated in accordance with the present disclosure that includes a polyoxymethylene polymer, an impact modifier comprising a thermoplastic elastomer, and one or more plasticizers in accordance with the present disclosure without having to incorporate into the composition a coupling agent, particularly an isocyanate coupling agent. In particular, the plasticizers of the present disclosure can produce compositions having physical properties that are substantially equivalent to or better than an identical composition also containing the coupling agent. Removal of the coupling agent simplifies processing and improves cost. In addition, many different polyoxymethylene polymers may be incorporated into the composition instead of having to rely on particular polyoxymethylene polymers that include functional groups for reaction with the coupling agent.

A plasticizer is generally a substance incorporated into the composition to increase flexibility. The plasticizer reduces the melt viscosity and decreases the elastic modulus of molded parts made from the composition. Plasticizers can include organic substances which react physically with the components of the composition to form a homogeneous physical unit, whether it is by means of swelling or dissolving or any other.

As described above, in one embodiment, the plasticizer has a relatively high melting point. The molecular weight (average number molecular weight) of the plasticizer can generally be from about 100 g/mol to about 1,000 g/mol. In one embodiment, the plasticizer can have a molecular weight of greater than 200 g/mol, such as greater than about 300 g/mol, such as greater than about 320 g/mol.

In one embodiment, the plasticizer comprises an alkylene glycol hexanoate, particularly an alkylene glycol bis-hexanoate. In one particular embodiment, for instance, the plasticizer may comprise triethylene glycol bis(2-ethylhexanoate).

In an alternative embodiment, the plasticizer may comprise an alkylene glycol benzoate. For instance, the plasticizer may comprise a dialkylene glycol dibenzoate. In one particular embodiment, the plasticizer may comprise di(propylene glycol)dibenzoate.

The above plasticizers have been found to be resistant to evaporative loss, to provide improved weld line flexibility and strength, and to have other excellent physical properties, such as properties related to flexibility and modulus. For example, the polymer composition of the present disclosure can display a strain at break according to ISO Test No. 527 of greater than about 55%, such as greater than about 60%, such as even greater than about 65%. The strain at break is typically less than about 100%.

In general, one or more plasticizers can be present in the polymer composition in an amount from about 1% to about 40% by weight. In one embodiment, the one or more plasticizers may be present in the polymer composition in an amount less than about 30% by weight, such as in an amount less than about 25% by weight, such as in an amount less than 20% by weight, such as in an amount less than about 15% weight, such as in an amount less than about 10% by weight, such as in an amount less than about 8% by weight. In one particular embodiment, a plasticizer is present in the composition in an amount from about 3% to about 8% by weight. In one embodiment, a plasticizer can be added to the composition in order to decrease the amount of impact modifier present in the composition, In this regard, the amount of impact modifier can be decreased as the amount of plasticizer is increased.

As described above, one or more plasticizers are incorporated into the polymer composition in combination with a polyoxymethylene polymer and an impact modifier.

Generally, the polyoxymethylene polymer may comprise a homopolymer or a copolymer and can include end caps/terminal groups. The polymers may be obtained by polymerizing formaldehyde, trioxane, or a mixture of trioxane and dioxolane, where the polymerization can be initiated cationically or anionically. The homopolymers can contain primarily oxymethylene units in the polymer chain. Polyacetal copolymers, on the other hand, may contain oxyalkylene units alongside oxymethylene units. The oxyalkylene units may contain, for instance, from about 2 to about 8 carbon units and may be linear or branched. In one embodiment, the homopolymer or copolymer can have hydroxy end groups that have been chemically stabilized to resist degradation by esterification or by etherification.

As described above, the polymers are generally prepared by polymerizing formaldehyde, trioxane, or a mixture of trioxane and dioxolane, preferably in the presence of suitable catalysts. Examples of suitable catalysts are boron trifluoride and trifluoromethanesulfonic acid.

The polyoxymethylene polymer may have terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O— repeat units.

In one particular embodiment, the polyoxymethylene polymer contained in the plasticized, impact modified polyoxymethylene composition has a relatively high number of functional groups. For example, at least about 25%, such as at least about 50%, such as at least about 60%, such as at least about 70%, such as at least about 80% of the terminal groups on the polyoxymethylene polymer are functional groups.

For instance, the polyoxymethylene polymer can include a significant number of hydroxyl groups in the terminal position. In one embodiment, ether end groups on the polyoxymethylene polymer can be replaced with ethoxy hydroxy end groups. The hydroxyl group content of the resulting polyoxymethylene polymer (POM-OH) can be further increased by using a comonomer with hydroxyl side chains. The hydroxyl group concentration may also be increased through the use of a polyoxymethylene moiety with a dendrimer structure. The polyoxymethylene polymer can include more than 20 hydroxyl groups per chain, such as more than 25 hydroxyl groups per chain. In one embodiment, for instance, the polyoxymethylene polymer may include from about 20 hydroxyl groups per chain to about 50 hydroxyl groups per chain.

More particularly, the polyoxymethylene polymer can have terminal hydroxyl groups, for example, hydroxyethylene groups and/or hydroxyl side groups in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present, In another embodiment, the polyoxymethylene polymer can have other terminal groups, such as alkoxy groups, formate groups, acetate groups, or aldehyde groups. It should be understood that the total number of terminal groups present includes all side terminal groups. The functionalized polyoxymethylene can be present in the polymer composition in an amount ranging from about 30% by weight to about 95% by weight, such as in an amount ranging from about 40% by weight to 90% by weight, such as in an amount ranging from 45% by weight to about 85% by weight based on the total weight of the polymer composition.

In one embodiment, the polyoxymethylene polymer can have a content of terminal hydroxyl groups of at least 5 mmol/kg, such as at least 10 mmol/kg, such as at least 15 mmol/kg. In one embodiment, the terminal hydroxyl group content ranges from 18 to 50 mmol/kg. Polyoxymethylene polymers containing relatively high number of hydroxyl groups in the terminal position are desired when the composition also contains a coupling agent, such as an isocyanate coupling agent, that couples the impact modifier to the polyoxymethylene polymer. The plasticizers of the present disclosure, however, have been found to increase the physical properties of the polymer composition to an extent that a coupling agent may not be needed in certain embodiments. Thus, in one embodiment, the polymer composition of the present disclosure contains substantially no coupling agents, particularly isocyanate coupling agents. For instance, in one embodiment, the composition contains coupling agents in an amount less than 0.1% by weight, such as in an amount less than 0.08% by weight, such as in an amount less than 0.05% by weight, In one particular embodiment, the composition is completely free of any coupling agents, such as isocyanate coupling agents.

By eliminating the need for a coupling agent, any suitable polyoxymethylene polymer may be incorporated into the composition. In particular, in one embodiment, polyoxymethylene polymers may be used that have relatively low amounts of hydroxyl terminal groups. For instance, in one embodiment, the polyoxymethylene polymer present in the composition contains less than about 4 mmol/kg of hydroxyl terminal groups, such as less than about 3 mmol/kg, such as less than about 2 mmol/kg.

The polyoxymethylene polymer present in forming the plasticized, impact modified polyoxymethylene composition can generally have a melt volume rate (MVR) of less than 50 cm³/10 min, such as from about 1 to about 40 cm³/10 min, such as from about 2 to 20 cm³/10 min determined according to ISO 1133 at 190° C. and 2.16 kg.

The amount of polyoxymethylene polymer present in the polymer composition of the present disclosure can vary depending upon the particular application. In one embodiment, for instance, the polymer composition contains functionalized polyoxymethylene polymer in an amount ranging from about 30% by weight to about 95% by weight, such as in an amount ranging from about 40% by weight to about 90% by weight, such as in an amount ranging from about 45% by weight to about 85% by weight based on the total weight of the polymer composition.

The polymer composition further comprises an impact modifier such as a thermoplastic elastomer. Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE-E), thermoplastic polyamide elastomers (TPE-A) and in particular thermoplastic polyurethane elastomers (TPE-U). The above thermoplastic elastomers have active hydrogen atoms which can be reacted with coupling reagents and/or the polyoxymethylene polymer. Examples of such groups are urethane groups, amido groups, amino groups or hydroxyl groups. For instance, terminal polyester dial flexible segments of thermoplastic polyurethane elastomers have hydrogen atoms which can react, for example, with isocyanate groups.

In one particular embodiment, a thermoplastic polyurethane elastomer is used. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a dial chain extender. Representative long-chain diols are polyester dials such as poly(butylene adipate)diol, poly(ethylene adipate)diol and poly(ε-caprolactone)diol; and polyether dials such as poly(tetramethylene ether)glycol, poly(propylene oxide)glycol, poly(ethylene oxide)glycol, polycarbonate diol and/or a polyester polycarbonate diol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

In one embodiment, the Shore A hardness of the thermoplastic elastomer is less than about 98, such as less than about 95, such as less than about 93 when tested according to ISO Test 868. The Shore A hardness of the material is generally greater than about 80, such as greater than about 85.

The amount of thermoplastic elastomer contained in the polymer composition can vary depending upon various factors. For instance, the thermoplastic elastomer can be present in an amount ranging from about 0.5% by weight to about 50% by weight. In one embodiment, plasticizers may be used in accordance with the present disclosure in order to minimize the amount of impact modifier present in the composition. Thus, in one embodiment, the thermoplastic elastomer or impact modifier may be present in an amount less than 15% by weight, such as in an amount less than about 10% by weight, such as in an amount less than about 8% by weight, such as in an amount less than about 5% by weight, such as in an amount less than about 2.5% by weight. The thermoplastic elastomer is generally present in an amount of at least about 0.5% by weight, such as in an amount of least about 1% by weight.

The weight ratio between the thermoplastic elastomer and the plasticizer can also vary depending upon various different factors. In general, the weight ratio between the thermoplastic elastomer and the plasticizer can be from about 1:1 to about 1:5, such as from about 1:1.5 to about 1:3.5.

In one embodiment of the present disclosure, as described above, the composition contains little or no coupling agent. In an alternative embodiment, however, a coupling agent may be present.

The coupling agent can form bridging groups between the polyoxymethylene polymer and the thermoplastic elastomer. Further, the coupling agent may be capable of forming covalent bonds with the terminal hydroxyl groups on the polyoxymethylene polymer and with active hydrogen atoms on the thermoplastic elastomer. In this manner, the thermoplastic elastomer becomes coupled to the polyoxymethylene through covalent bonds.

When a thermoplastic elastomer is included in the composition of the present disclosure, the poloxymethylene polymer, thermoplastic elastomer, and coupling agent can be melt blended in an extruder, and then various loadings of texturizing agents, such as glass fibers, can be added.

A suitable coupling agent is a polyisocyanate, preferably organic diisocyanate, more preferably a polyisocyanate selected from the group consisting of aliphatic diisocyanates, cycloaliphatic diisocyanates, aromatic diisocyanates and mixtures thereof.

A wide range of polyfunctional, such as trifunctional or bifunctional coupling agents, may be used. In one embodiment, the coupling agent comprises a diisocyanate, such as an aliphatic, cycloaliphatic and/or aromatic diisocyanate. The coupling agent may be in the form of an oligomer, such as a trimer or a dimer.

In one embodiment, the coupling agent comprises a diisocyanate or a triisocyanate which is selected from 2,2-, 2,4-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diilsocyanate; 2,4-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic polyisocyanate is used, such as 4,4′-diphenylmethane diisocyanate (MDI).

When present, the polymer composition generally contains the coupling agent in an amount from about 0.1% to about 10% by weight based on the total weight of the polymer composition. In one embodiment, for instance, the coupling agent is present in an amount ranging from about 0.2% by weight to about 5% by weight. In another embodiment, the coupling agent is present in an amount from about 0.5% to about 2.5% by weight. To ensure that the thermoplastic elastomer has been completely coupled to the polyoxymethylene polymer, in one embodiment, the coupling agent can be added to the polymer composition in molar excess amounts when comparing the reactive groups on the coupling agent with the amount of terminal hydroxyl groups on the polyoxymethylene polymer.

The polymer composition of the present disclosure can also optionally contain a stabilizer and/or various other known additives. Such additives can include, for example, antioxidants, acid scavengers, UV stabilizers or heat stabilizers. In addition, the molding material or the molding may contain processing auxiliaries, for example adhesion promoters, lubricants, nucleating agents, demolding agents, fillers, reinforcing materials or antistatic agents and additives which impart a desired property to the molding material or to the molding.

For instance, in one embodiment, an ultraviolet light stabilizer may be present. The ultraviolet light stabilizer may comprise a benzophenone, a benzotriazole, or a benzoate. Particular examples of ultraviolet light stabilizers include 2,4-dihydroxy benzophenone, 2-hydroxy-4-methoxybenzophenone, 2-(2′-hydroxy-3′,5′-di-t-butylphenyl)benzotriazole, 2-(2′-hydroxy-3′-t-butyl-5′-methylphenyl)-5-chlorobenzotriazole, 2,4-dihydroxybenzophenone, 2-hydroxy-4-methoxybenzophenone, 2-hydroxy-4-octoxybenzophenone, and 5,5′-methylene bis(2-hydroxy-4-methoxybenzophenone); 2-(2′-hydroxyphenyl)benzotriazoles, e.g., 2-(2′-hydroxy-5′-methylphenyl)benzotriazole, 2-(2′-hydroxy-5′-t-octylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′-t-butyl-5′-methylphenyl)-5-chlorobenzotriazole, 2-(2′-hydroxy-3′,5′-dicumylphenyl)benzotriazole, and 2,2′-methylene bis(4-t-octyl-6-benzotriazolyl)phenol, phenylsalicylate, resorcinol monobenzoate, 2,4-di-t-butylphenyl-3′,5′-di-t-butyl-4′-hydroxybenzoate, and hexadecyl-3,5-di-t-butyl-4-hydroxybenzoate; substituted oxanilides, e.g., 2-ethyl-2′-ethoxyoxanilide and 2-ethoxy-4′-dodecyloxanilide; cyanoacrylates, e.g., ethyl-α-cyano-β,β-diphenylacrylate and methyl-2-cyano-3-methyl-3-(p-methoxyphenyl)acrylate or mixtures thereof. A specific example of an ultraviolet light absorber that may be present is UV 234, which is a high molecular weight ultraviolet light absorber of the hydroxyl phenyl benzotriazole class. The UV light absorber, when present, can be present in the polymer composition in an amount ranging from about 0.1% by weight to about 2% by weight, such as in an amount ranging from about 0.25% by weight to about 1% by weight based on the total weight of the polymer composition.

In one embodiment, the polymer composition may also include a formaldehyde scavenger, such as a nitrogen-containing compound. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Advantageous compounds of this nature are aminopyridine and compounds derived therefrom. Any of the aminopyridines is in principle suitable, for example 2,6-diaminopyridine, substituted and dimeric aminopyridines, and mixtures prepared from these compounds. Other advantageous materials are polyamides and dicyane diamide, urea and its derivatives and also pyrrolidone and compounds derived therefrom. Examples of suitable pyrrolidones are imidazolidinone and compounds derived therefrom, such as hydantoines, derivatives of which are particularly advantageous, and those particularly advantageous among these compounds are allantoin and its derivatives. Other particularly advantageous compounds are triamino-1,3,5-triazine(melamine) and its derivatives, such as melamine-formaldehyde condensates and methylol melamine. Oligomeric polyamides are also suitable in principle for use as formaldehyde scavengers. The formaldehyde scavenger may be used individually or in combination.

Further, the formaldehyde scavenger can be a guanidine compound which can include an aliphatic guanamine-based compound, an alicyclic guanamine-based compound, an aromatic guanamine-based compound, a hetero atom-containing guanamine-based compound, or the like. The formaldehyde scavenger can pe present in the polymer composition in an amount ranging from about 0.005% by weight to about 2% by weight, such as in an amount ranging from about 0.0075% by weight to about 1% by weight based on the total weight of the polymer composition.

In one embodiment, the composition may also contain a nucleant. The nucleant, for instance, may increase crystallinity and may comprise an oxymethylene terpolymer. In one particular embodiment, for instance, the nucelant may comprise a terpolymer of butanediol diglycidyl ether, ethylene oxide, and trioxane. The nucleant can be present in the composition in an amount ranging from about 0.05% by weight to about 2% by weight based on the total weight of the polymer composition.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (IRGANOX® 1010, BASF), triethylene glycol bis[3-(3-tert-butyl-4-hydroxy-5-methylphenyl)propionate] (IRGANOX® 245, BASF), 3,3′-bis[3-(3,5-di-tert-butyl-4-hydroxyphenyl)propionohydrazide] (IRGANOX® MD 1024, BASF), hexamethylene glycol bis[3-(3,5-di-cert-butyl-4-hydroxyphenyl)propionate] (IRGANOX® 259, BASF), and 3,5-di-tert-butyl-4-hydroxytoluene (LOWINOX® BHT, Chemtura). The above compounds may be present in the polymer composition in an amount ranging from about 0.01% by weight to about 1% by weight based on the total weight of the polymer composition.

Light stabilizers that may be present in addition to the ultraviolet light stabilizer in the composition include sterically hindered amines. Hindered amine light stabilizers that may be used include oligomeric compounds that are N-methylated. For instance, another example of a hindered amine light stabilizer comprises ADK STAB LA-63 light stabilizer available from Adeka Palmarole. The light stabilizers, when present, can be present in the polymer composition in an amount ranging from about 0.1% by weight to about 2% by weight, such as in an amount ranging from about 0.25% by weight to about 1% by weight based on the total weight of the polymer composition.

In one embodiment, the composition may also contain one or more lubricants. The lubricant may comprise a polymer wax composition. Lubricants that may be included in the composition include, for instance, N,N′-ethylene bisstearamide or ethylene bis-stearamide (EBS) wax, which is based on monocarboxylic acids derived from naturally occurring vegetable oils. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. Lubricants can generally be present in the polymer composition in an amount ranging from about 0.005% by weight to about 2% by weight, such as in an amount ranging from about 0.0075% by weight to about 1% by weight, such as in an amount ranging from about 0.01% by weight to about 0.5% by weight based on the total weight of the polymer composition.

In addition to the above components, the polymer composition may also contain an acid scavenger. The acid scavenger may comprise, for instance, an alkaline earth metal salt. For instance, the acid scavenger may comprise a calcium salt, such as a calcium citrate. The acid scavenger may be present in an amount ranging from about 0.01% by weight to about 1% by weight based on the total weight of the polymer composition.

Further, the polymer composition may also contain a compatibilizer such as a phenoxy resin. Generally, the phenoxy resin can be present in the composition in an amount ranging from about 0.01% by weight to about 1% by weight based on the total weight of the polymer composition.

Any of the above additives can be added to the polymer composition alone or combined with other additives. In general, each additive is present in the polymer composition in an amount less than about 5% by weight, such as in an amount ranging from about 0.005% by weight to about 2% by weight, such as in an amount ranging from about 0.0075% by weight to about 1% by weight, such as from about 0.01% by weight to about 0.5% by weight based on the total weight of the polymer composition.

The plasticized, impact modified polyoxymethylene composition discussed above can be formed in to pellets and can be compounded with other components such as a conductive filler composition.

The conductive filler composition can comprise a conductive filler and a polymer carrier.

The conductive filler can include conductive particles, powders, fibers or combinations thereof. For instance, the conductive filler may comprise metal powders, metal flakes, metal fibers (i.e., stainless steel fibers), carbon powder, carbon fibers, carbon black, carbon nanotubes, or combinations thereof.

The conductive filler can be present in the polymer composition of the present disclosure in an amount ranging from about 1% by weight to about 30% by weight, such as in an amount ranging from about 1.5% by weight to about 25% by weight, such as in an amount ranging from about 2% by weight to about 20% by weight, based on the total weight of the polymer composition.

An almost limitless variety of polymer articles may be formed from the polymer composition of the present disclosure. Shaped articles can be made from the disclosed polymer composition according to the present disclosure using various different processes. In one embodiment, for instance, the shaped articles can be formed through an extrusion process. In an alternative embodiment, the articles may be formed through a blow molding process. Other embodiments include injection molding and rotational molding. The shaped article can be a tube, any other molded article, or combination thereof. It is also to be understood that the articles can be corrugated, flat, or a combination thereof. For example, the article formed can include any pipe, tube, hose, line or other article and can have ESD capabilities when combined with a conductive filler. The article may also be multilayered such that they contain one or more layers in addition to a layer containing the ESD polymer composition of the present disclosure.

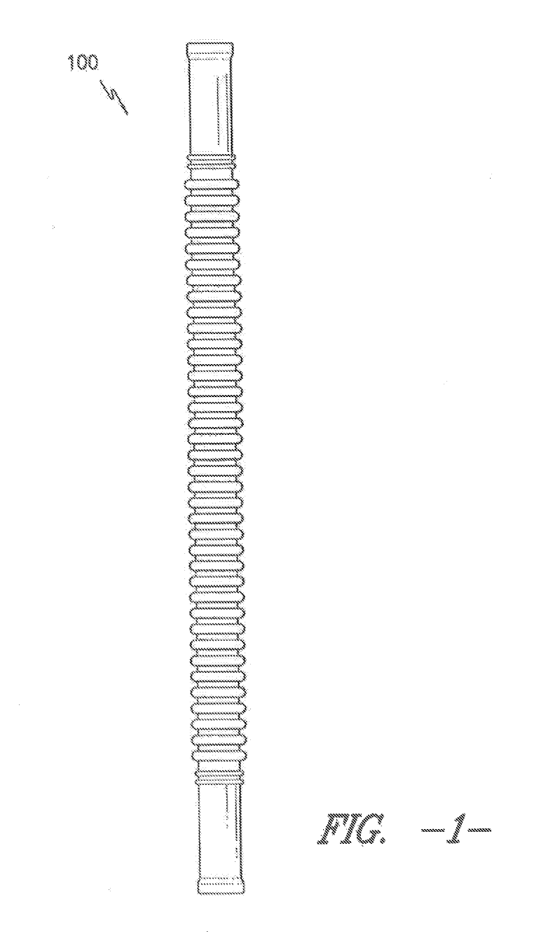

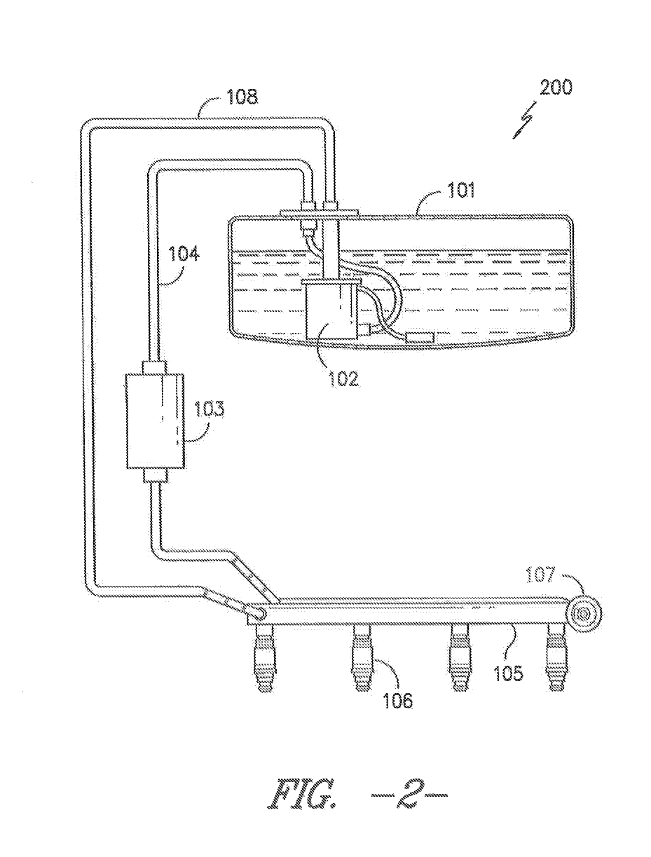

FIGS. 1-2 show various articles that can be formed from the polymer composition of the present disclosure. In FIG. 1, a corrugated tube 100 is shown that is formed by extrusion of pellets of the polymer composition of the present disclosure. Meanwhile, FIG. 2 shows an automotive fuel system 200 having a fuel tank 101, a fuel pump 102, a fuel filter 103, a delivery fuel line 104, a fuel rail 105, an injector 106, a pressure regulator 107, and a return fuel line 108. At least the delivery fuel line 104 and the return fuel line 108 can be formed from polymer compositions of the present disclosure.

The present disclosure may be better understood with reference to the following example.

### EXAMPLE

Various different polymer compositions made in accordance with the present disclosure were formulated and compared to compositions not containing plasticizers. The polymer compositions were tested for various physical properties.

The following polymer compositions were formulated:
Sample 1 contained a polyoxymethylene polymer; an isocyanate coupling agent (MDI) and a thermoplastic polyurethane elastomer.
Sample 2 contained a polyoxymethylene polymer; a coupling agent (MDI); a thermoplastic polyurethane elastomer, and a butyl benzene sulfonamide plasticizer.
Sample 3 contained a polyoxymethylene polymer; a thermoplastic polyurethane elastomer, and a butyl benzene sulfonamide plasticizer.
Sample 4 contained a polyoxymethylene polymer; a coupling agent (MDI), a thermoplastic polyurethane elastomer, and a triethylene glycol bis-2-ethyl hexanoate plasticizer.
Sample 5 contained a polyoxyrnethylene polymer; a thermoplastic polyurethane elastomer, and a triethylene glycol bis-2-ethyl hexanoate plasticizer.
Sample 6 contained a polyoxymethylene polymer; a coupling agent (MDI); a thermoplastic polyurethane elastomer, and a di-propylene glycol dibenzoate plasticizer.
Sample 7 contained a polyoxymethylene polymer; a coupling agent (MDI), a thermoplastic polyurethane elastomer, and a triethylene glycol bis-2-ethyl hexanoate plasticizer.
Sample 8 contained a polyoxymethylene polymer, a thermoplastic polyurethane elastomer, and a triethylene glycol bis-2-ethyl hexanoate plasticizer.

In Samples 1-7 above, the polyoxymethylene polymer contained a relatively high number of terminal hydroxyl groups, particularly greater than 15 mmol/kg. In Sample 1, the polyoxymethylene polymer had a melt index of 9 g/10 min. In Samples 2-7, the polyoxymethylene polymer had a melt index of 2.3 g/10 min. Sample 8 contained a polyoxymethylene polymer having a melt index of 2.5 g/10 min. In Sample 8, the polyoxymethylene polymer contained a relatively low number of terminal hydroxyl groups, such as less than 5 mmol/kg.

The following tests were performed on the polymer compositions.

Melt index was determined according to ISO Test No. 1133 at 190° C. and at a load of 2.16 kg.

Tensile modulus, tensile stress at yield, strain at yield, and strain at break were tested according to ISO Test No. 527. Modulus and strength measurements were made on the same test strip sample made according to ISO standards having a length of 80 mm, thickness of 10 mm, and width of 4 mm. The testing temperature was 23° C. and the testing speed was 50 mm/min.

Weld Line testing or double-gated tensile bar testing was also conducted according to ISO Test No. 527.

Charpy Notched impact strength was determined at 23° C. and at −30° C. according to ISO Test No. 179-1/1eA (CNI).

Some of the polymer compositions were also aged in air at 90° C. for 1,000 hours and retested.

The following results were obtained:

| | | Sample | Sample | Sample | Sample | Sample | Sample | Sample | Sample |
|---|---|---|---|---|---|---|---|---|---|
| | Units | 1 | 2 | 3 | 4 | 5 | 6 | 7 | 8 |
| TPU | wt. % | 9 | 2 | 2 | 2 | 2 | 2 | 2 | 2 |
| MDI | wt. % | 0.3 | 0.4 | 0 | 0.4 | 0 | 0.4 | 0.4 | 0 |
| Plasticizer | wt. % | NT | 5 | 5 | 5 | 5 | 5 | 5 | 5 |
| MI | g/10 min | 5.5 | 2.6 | 2.7 | 2.3 | 2.5 | 2.8 | 2.4 | 3.3 |
| Tensile Modulus | MPa | 2083 | 1763 | 1653 | 1802 | 1662 | 1771 | 1812 | 1631 |
| Tensile Stress | MPa | 51.0 | 53.9 | 52.6 | 51.7 | 51.9 | 53 | 51.9 | 49.7 |
| @Yield | | | | | | | | | |
| Tensile Stress | MPa | 50.9 | NT | NT | NT | NT | NT | NT | 26.5 |
| @Break | | | | | | | | | |
| Strain @Yield | % | 12.0 | 14.2 | 14.1 | 15.2 | 15.0 | 13.5 | 14.8 | 15.6 |
| Strain @Break | % | 47.6 | 53.4 | 59.3 | 61.0 | 66.0 | 59.0 | 71.1 | 69.0 |
| Weld Line Strain | % | No | 14.2 | 13.8 | 15.0 | 15.0 | 14.5 | 14.9 | 14.9 |
| @ Yield | | yield | | | | | | | |
| Weld Line Strain | % | 8.4 | 21.9 | 21.4 | 17.8 | 15.6 | 17.3 | 18.3 | 26.5 |
| @ Break | | | | | | | | | |
| Charpy Notched | kJ/m² | 14.1 | 13.7 | 12.5 | 15.4 | 15.5 | 15.3 | 14.6 | 17.9 |
| (23 C.) | | | | | | | | | |
| Charpy Notched | kJ/m² | 7.9 | 9.4 | 8.1 | 10.9 | 10.7 | 8.5 | 9.2 | 12.9 |
| (−30 C.) | | | | | | | | | |

NT—Not Tested

| | | Sample | Sample | Sample | Sample | Sample | Sample | Sample | Sample |
|---|---|---|---|---|---|---|---|---|---|
| | Units | 1 | 2 | 3 | 4 | 5 | 6 | 7 | 8 |
| Flex Modulus | MPa | 1972 | NT | NT | NT | NT | NT | NT | NT |
| Flex Stress | MPa | 52.6 | NT | NT | NT | NT | NT | NT | NT |
| Tensile Stress Ret | % | 96 | NT | NT | NT | NT | 117 | NT | NT |
| 1000 hrs at 90 C. | | | | | | | | | |
| Tensile Break Strain | % | 44.3 | NT | NT | NT | NT | 47.5 | NT | NT |
| 1000 hrs at 90 C. | | | | | | | | | |
| Notched Impact Ret | % | 62 | NT | NT | NT | NT | 53 | NT | NT |
| 1000 hrs at 90 C. | | | | | | | | | |
| Notched Impact | kJ/m² | 8.7 | NT | NT | NT | NT | 8 | NT | NT |
| 1000 hrs at 90 C. | | | | | | | | | |

NT—Not Tested

Sample Nos. 2, 4 and 6 were also tested for mass loss (%) during heat aging at 90° C. in a hot air oven. In order to conduct the mass loss test, the ISO Test bars are placed in a hot air oven at 90° C. The weight of the sample prior to being placed in the oven is measured and the weight of the sample after a desired period of time within the oven is measured. A percent mass loss is calculated based upon the initial weight and the final weight. Sample Nos. 4 and 6 made in accordance with the present disclosure had a mass loss of less than 0.5% after 600 hours at 90° C. Sample No. 2, on the other hand, had a mass loss of approximately 1.3% after 600 hours at 90° C. The above demonstrates that plasticizers used in accordance with the present disclosure have minimal evaporative loss

Eight more samples were formulated and tested. The polyoxymethylene polymer used contained a relatively high amount of terminal hydroxyl groups as described above. Sample Nos. 9, 10, 13 and 14 did not contain any plasticizer. Samples 11 and 12 contained a butyl benzene sulfonamide plasticizer. Sample Nos. 15 and 16 contained a triethylene glycol bis-2-ethyl hexanoate plasticizer. The compositions were tested for various properties after long term heat aging. In particular, the test specimens were aged in air at 125° C. and at 130° C. for 1000 hours. The following results were obtained.

| | | Sample | Sample | Sample | Sample | Sample | Sample | Sample | Sample |
|---|---|---|---|---|---|---|---|---|---|
| | Units | 9 | 10 | 11 | 12 | 13 | 14 | 15 | 16 |
| TPU | wt. % | 18 | 18 | 12 | 12 | 18 | 18 | 12 | 12 |
| MDI | wt. % | 0.25 | 0.25 | 0.5 | 0.25 | 0.25 | 0.25 | 0.25 | 0.25 |
| Plasticizer | wt. % | 0 | 0 | 5 | 5 | 0 | 0 | 5 | 5 |
| MI | g/10 min | 28.4 | 28.4 | 39.4 | 36.6 | 20.2 | 20.2 | 39 | 39 |
| Tensile Modulus | MPa | 1771 | 1771 | 1539 | 1399 | 1669 | 1669 | 1600 | 1600 |
| Tensile Stress | MPa | 42.5 | 42.5 | 40.7 | 40.2 | 40.1 | 40.1 | 37.5 | 37.5 |
| @Yield | | | | | | | | | |
| Tensile Stress | MPa | 37.1 | 37.1 | 35.2 | 36.5 | 37.2 | 37.2 | 32.9 | 32.9 |
| @Break | | | | | | | | | |
| Strain @Yield | % | 9.9 | 9.9 | 12.4 | 13.1 | 10.8 | 10.8 | 11.4 | 11.4 |
| Strain @Break | % | 81.7 | 81.7 | 100.8 | 69.3 | 58.5 | 58.5 | 89.7 | 89.7 |
| Weld Line Strain | % | 11.4 | 11.4 | 12.7 | 13.2 | 0 | 0 | 0 | 0 |
| @ Yield | | | | | | | | | |
| Weld Line Strain | % | 34.6 | 34.6 | 20.6 | 13.8 | 3.6 | 3.6 | 4.8 | 4.8 |
| @ Break | | | | | | | | | |
| Charpy Notched | kJ/m² | 13.4 | 13.4 | 10.3 | 8 | 9.9 | 9.9 | 8.8 | 8.8 |
| (23 C.) | | | | | | | | | |
| Charpy Notched | kJ/m² | 9 | 9 | 7.6 | NT | NT | NT | NT | NT |
| (−30 C.) | | | | | | | | | |

NT—Not Tested

| | | Sample | Sample | Sample | Sample | Sample | Sample | Sample | Sample |
|---|---|---|---|---|---|---|---|---|---|
| | Units | 9 | 10 | 11 | 12 | 13 | 14 | 15 | 16 |
| Tensile Stress Ret | % | 117.8 | NT | 133.2 | 126.2 | 107.8 | NT | 130.7 | NT |
| 1000 hrs at 125 C. | | | | | | | | | |
| Tensile Break Strain | % | 12.6 | NT | 6.7 | 33.8 | 36.4 | NT | 16.1 | NT |
| 1000 hrs at 125 C. | | | | | | | | | |
| Notched Impact Ret | % | NT | NT | NT | 67.5 | 64.7 | NT | 42.1 | NT |
| 1000 hrs at 125 C. | | | | | | | | | |
| Notched Impact | kJ/m² | NT | NT | NT | 5.4 | 6.4 | NT | 3.7 | NT |
| 1000 hrs at 125 C. | | | | | | | | | |
| Tensile Stress Ret | % | NT | 116.7 | NT | NT | NT | 107.0 | NT | 128.6 |
| 1000 hrs at 130 C. | | | | | | | | | |
| Tensile Break Strain | % | NT | 14.4 | NT | NT | NT | 31.8 | NT | 34.5 |
| 1000 hrs at 130 C. | | | | | | | | | |
| Notched Impact Ret | % | NT | NT | NT | NT | NT | NT | NT | 59.1 |
| 1000 hrs at 130 C. | | | | | | | | | |
| Notched Impact | kJ/m² | NT | NT | NT | NT | NT | 6.1 | NT | 5.2 |
| 1000 hrs at 130 C. | | | | | | | | | |

NT—Not Tested

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition comprising:
a polyoxymethylene polymer;
a thermoplastic elastomer;
a plasticizer; and
wherein the polymer composition displays a mass loss of less than about 1% after 600 hours at 90° C.

2. A polymer composition as defined in claim 1, wherein the composition displays a mass loss of less than about 0.7% after 600 hours at 90° C.

3. A polymer composition as defined in claim 1, wherein the plasticizer has a boiling point of 760 mmHg of greater than about 320° C.

4. A polymer composition as defined in claim 1, wherein the plasticizer comprises a dialkylene glycol dibenzoate.

5. A polymer composition as defined in claim 1, wherein the plasticizer comprises an alkylene glycol hexanoate.

6. A polymer composition as defined in claim 1, wherein the plasticizer comprising a triethylene glycol bis(2-ethylhexanoate).

7. A polymer composition as defined in claim 1, wherein the thermoplastic elastomer is present in the composition in an amount less than 5% by weight.

8. A polymer composition as defined in claim 1, wherein the thermoplastic elastomer comprises a thermoplastic polyurethane elastomer.

9. A polymer composition as defined in claim 1, wherein the composition does not contain an isocyanate coupling agent.

10. A polymer composition as defined in claim 1, wherein the polyoxymethylene polymer contains hydroxyl end groups in an amount less than 4 mmol/kg.

11. A polymer composition as defined in claim 1, wherein the composition displays a strain at break of greater than 60%.

12. A polymer composition as defined in claim 1, wherein the polyoxymethylene polymer is present in the composition in an amount from about 40% by weight to about 95% by weight.

13. A polymer composition as defined in claim 1, wherein the composition further comprises a conductive filler.

14. A polymer composition as defined in claim 1, wherein the thermoplastic elastomer and the plasticizer are present in the composition at a weight ratio of from about 2:1 to about 1:5.

15. A polymer composition as defined in claim 1, wherein the composition has a charpy impact resistance at 30° C. of greater than above 9 kJ/m².

16. A polymer composition comprising:
a polyoxymethylene polymer;
a thermoplastic elastomer; and
a plasticizer comprising an alkylene glycol hexanoate, a dialkylene glycol dibenzoate, a triethylene glycol bis(2-ethylhexanoate), or mixtures thereof.

17. A polymer composition as defined in claim 16, wherein the plasticizer comprises a triethylene glycol bis(2-ethyl hexanoate).

18. A polymer composition as defined in claim 16, wherein the plasticizer comprises an alkylene glycol hexanoate.

19. A polymer composition as defined in claim 16, wherein the thermoplastic elastomer comprises a thermoplastic polyurethane elastomer and wherein the thermoplastic elastomer and the plasticizer are present in the composition at a weight ratio of from about 1:1 to about 1:5.

20. A shaped article formed at least in part from a polymer composition as defined in claim 1, wherein the shaped article comprises a tube.
